(19) United States
(12) Patent Application Publication
(10) Pub. No.: US 2024/0373507 A1
(43) Pub. Date: Nov. 7, 2024

(54) JOINING AND LEAVING MULTICAST SESSIONS

(71) Applicant: QUALCOMM Incorporated, San Diego, CA (US)

(72) Inventors: Amer CATOVIC, San Diego, CA (US); Miguel GRIOT, La Jolla, CA (US); Haris ZISIMOPOULOS, London (GB)

(21) Appl. No.: 18/573,333

(22) PCT Filed: Jul. 21, 2022
(86) PCT No.: PCT/US2022/074009

§ 371 Date: Dec. 21, 2023

(30) Foreign Application Priority Data
Aug. 11, 2021 (GR) 20210100548

(51) Int. Cl. H04W 76/40; H04L 65/1066; H04W 76/19

(52) U.S. Cl. CPC H04W 76/40; H04L 65/1066; H04W 76/19

(57) ABSTRACT

Various aspects of the present disclosure generally relate to wireless communication. In some aspects, a user equipment (UE) may transmit, to a network, a session establishment request that includes at least one indication associated with a multicast broadcast service (MBS) session. Accordingly, the UE may receive, from the network, a response to the session establishment request. Additionally, or alternatively, the UE may transmit, to the network, a session release request that includes at least one indication associated with the MBS session. Accordingly, the UE may receive, from the network, a response to the session release request. Numerous other aspects are described.

### CROSS-REFERENCE TO RELATED APPLICATION

This patent application claims priority to Greek patent application No. 20210100548, filed on Aug. 11, 2021, entitled “JOINING AND LEAVING MULTICAST SESSIONS.” The disclosure of the prior application is considered part of and is incorporated by reference in this patent application.

### FIELD OF THE DISCLOSURE

Aspects of the present disclosure generally relate to wireless communication and to techniques and apparatuses for joining and leaving multicast sessions.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to an apparatus for wireless communication at a user equipment (UE). The apparatus may include a memory and one or more processors, coupled to the memory. The one or more processors may be configured to transmit, to a network, a session establishment request that includes at least one indication associated with a multicast broadcast service (MBS) session. The one or more processors may be configured to receive, from the network, a response to the session establishment request.

Some aspects described herein relate to an apparatus for wireless communication at a network node. The apparatus may include a memory and one or more processors, coupled to the memory. The one or more processors may be configured to receive, from a UE, a session establishment request that includes at least one indication associated with an MBS session. The one or more processors may be configured to transmit, to the UE, a response to the session establishment request.

Some aspects described herein relate to an apparatus for wireless communication at a UE. The apparatus may include a memory and one or more processors, coupled to the memory. The one or more processors may be configured to transmit, to a network, a session release request that includes at least one indication associated with an MBS session. The one or more processors may be configured to receive, from the network, a response to the session release request.

Some aspects described herein relate to an apparatus for wireless communication at a network node. The apparatus may include a memory and one or more processors, coupled to the memory. The one or more processors may be configured to receive, from a UE, a session release request that includes at least one indication associated with an MBS session. The one or more processors may be configured to transmit, to the UE, a response to the session release request.

Some aspects described herein relate to a method of wireless communication performed by a UE. The method may include transmitting, to a network, a session establishment request that includes at least one indication associated with an MBS session. The method may include receiving, from the network, a response to the session establishment request.

Some aspects described herein relate to a method of wireless communication performed by a network node. The method may include receiving, from a UE, a session establishment request that includes at least one indication associated with an MBS session. The method may include transmitting, to the UE, a response to the session establishment request.

Some aspects described herein relate to a method of wireless communication performed by a UE. The method may include transmitting, to a network, a session release request that includes at least one indication associated with an MBS session. The method may include receiving, from the network, a response to the session release request.

Some aspects described herein relate to a method of wireless communication performed by a network node. The method may include receiving, from a UE, a session release request that includes at least one indication associated with an MBS session. The method may include transmitting, to the UE, a response to the session release request.

Some aspects described herein relate to a non-transitory computer-readable medium that stores a set of instructions for wireless communication by a UE. The set of instructions, when executed by one or more processors of the UE, may cause the UE to transmit, to a network, a session establishment request that includes at least one indication associated with an MBS session. The set of instructions, when executed by one or more processors of the UE, may cause the UE to receive, from the network, a response to the session establishment request.

Some aspects described herein relate to a non-transitory computer-readable medium that stores a set of instructions for wireless communication by a network node. The set of instructions, when executed by one or more processors of the network node, may cause the network node to receive, from a UE, a session establishment request that includes at least one indication associated with an MBS session. The set of instructions, when executed by one or more processors of the network node, may cause the network node to transmit, to the UE, a response to the session establishment request.

Some aspects described herein relate to a non-transitory computer-readable medium that stores a set of instructions for wireless communication by a UE. The set of instructions, when executed by one or more processors of the UE, may cause the UE to transmit, to a network, a session release request that includes at least one indication associated with an MBS session. The set of instructions, when executed by one or more processors of the UE, may cause the UE to receive, from the network, a response to the session release request.

Some aspects described herein relate to a non-transitory computer-readable medium that stores a set of instructions for wireless communication by a network node. The set of instructions, when executed by one or more processors of the network node, may cause the network node to receive, from a UE, a session release request that includes at least one indication associated with an MBS session. The set of instructions, when executed by one or more processors of the network node, may cause the network node to transmit, to the UE, a response to the session release request.

Some aspects described herein relate to an apparatus for wireless communication. The apparatus may include means for transmitting, to a network, a session establishment request that includes at least one indication associated with an MBS session. The apparatus may include means for receiving, from the network, a response to the session establishment request.

Some aspects described herein relate to an apparatus for wireless communication. The apparatus may include means for receiving, from a UE, a session establishment request that includes at least one indication associated with an MBS session. The apparatus may include means for transmitting, to the UE, a response to the session establishment request.

Some aspects described herein relate to an apparatus for wireless communication. The apparatus may include means for transmitting, to a network, a session release request that includes at least one indication associated with an MBS session. The apparatus may include means for receiving, from the network, a response to the session release request.

Some aspects described herein relate to an apparatus for wireless communication. The apparatus may include means for receiving, from a UE, a session release request that includes at least one indication associated with an MBS session. The apparatus may include means for transmitting, to the UE, a response to the session release request.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of a core network, in accordance with the present disclosure.

FIGS. 4A and 4B are diagrams illustrating examples of joining a multicast session, in accordance with the present disclosure.

FIG. 5 is a diagram illustrating an example associated with joining a multicast session, in accordance with the present disclosure.

FIG. 6 is a diagram illustrating an example of leaving a multicast session, in accordance with the present disclosure.

FIG. 7 is a diagram illustrating an example associated with leaving a multicast session, in accordance with the present disclosure.

FIGS. 8 and 9 are diagrams illustrating example processes associated with joining multicast sessions, in accordance with the present disclosure.

FIGS. 10 and 11 are diagrams illustrating example processes associated with leaving multicast sessions, in accordance with the present disclosure.

FIGS. 12 and 13 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

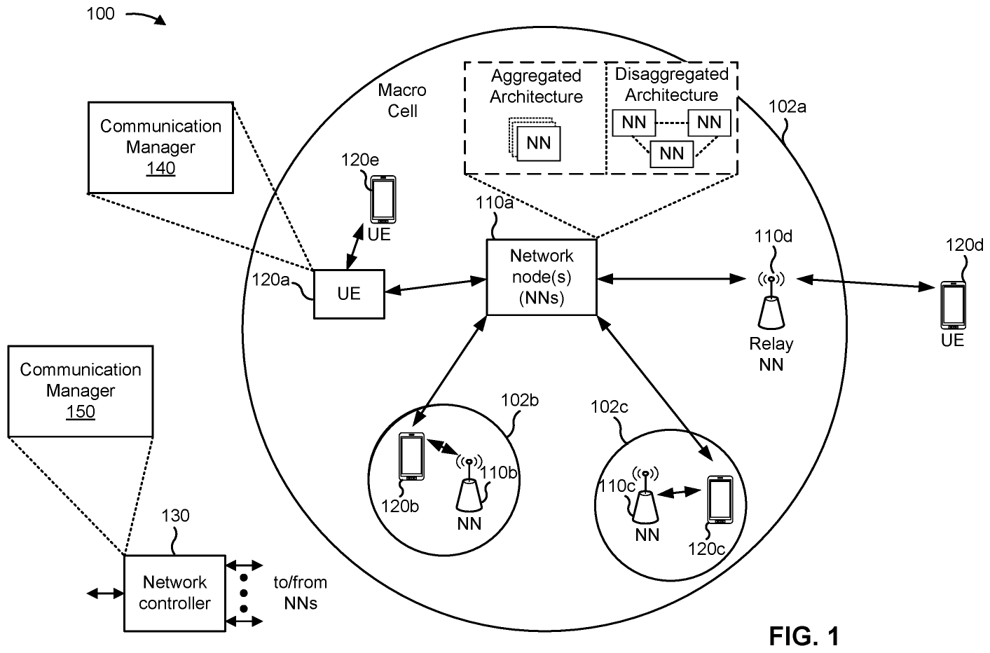

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As shown in FIG. 1, and as described in more detail elsewhere herein, the communication manager 140 may transmit, to a mobility function of a core network (e.g., to the network controller 130 via an RU), a protocol data unit (PDU) session establishment request that includes at least one indication associated with a multicast broadcast service (MBS) session. Accordingly, the communication manager 140 may receive, from a session function of the core network (e.g., from the network controller 130 via an RU), a response to the PDU session establishment request. Additionally, or alternatively, the communication manager 140 may transmit, to the session function of a core network, a PDU session release request that includes at least one indication associated with an MBS session, and receive, from the session function of the core network, a response to the PDU session release request. Additionally, or alternatively, the communication manager 140 may perform one or more other operations described herein.

In some aspects, the network controller 130 may include a communication manager 150. As described in more detail elsewhere herein, the communication manager 150 may receive, from the UE 120 (e.g., via a mobility function, such as a different portion of the network controller 130), a PDU session establishment request that includes at least one indication associated with an MBS session. Accordingly, the communication manager 150 may transmit, to the UE 120 (e.g., via an RU), a response to the PDU session establishment request. Additionally, or alternatively, the communication manager 150 may receive, from the UE 120 (e.g., via an RU), a PDU session release request that includes at least one indication associated with an MBS session, and transmit, to the UE 120 (e.g., via an RU), a response to the PDU session release request. Additionally, or alternatively, the communication manager 150 may perform one or more other operations described herein.

As indicated above, FIG. 1 is provided as an example. Other examples may differ from what is described with regard to FIG. 1.

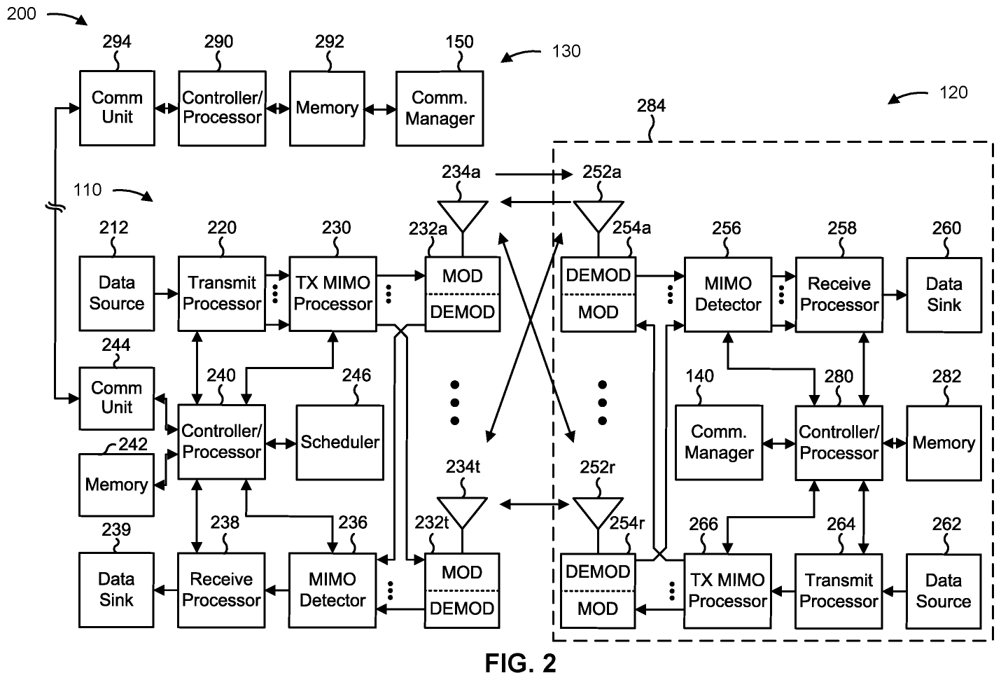

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

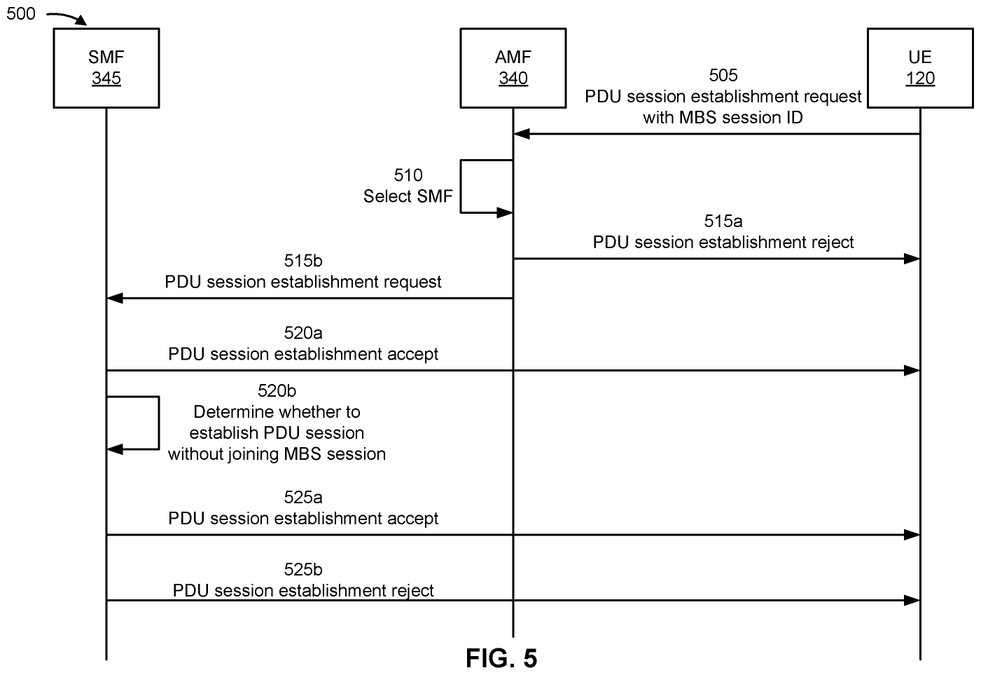

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5, 7, 8, 9, 10, 11, 12, and/or 13).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5, 7, 8, 9, 10, 11, 12, and/or 13).

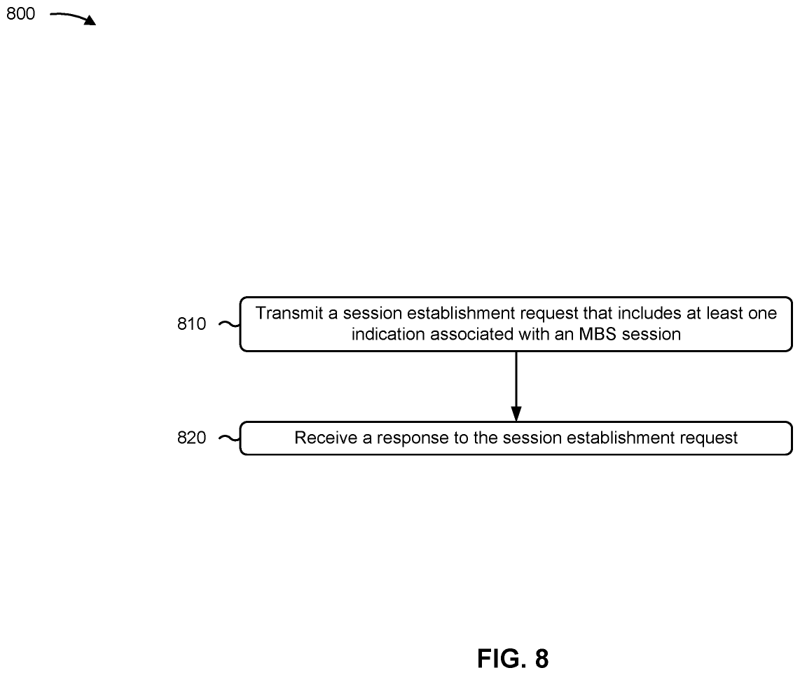

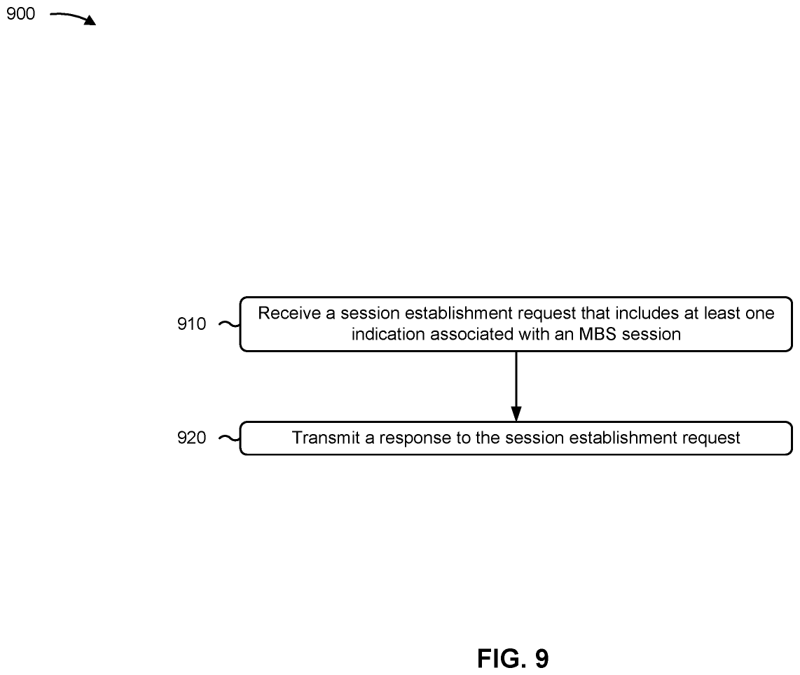

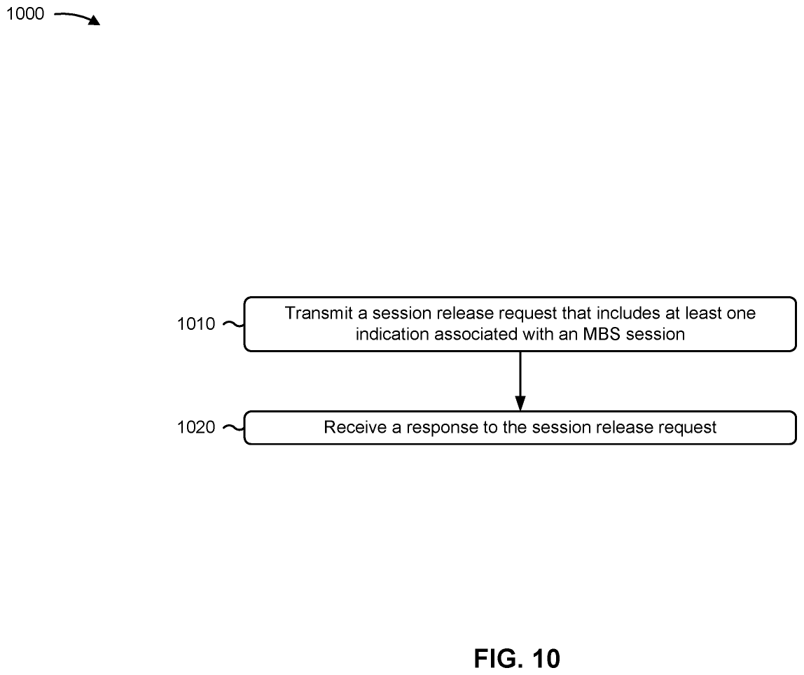

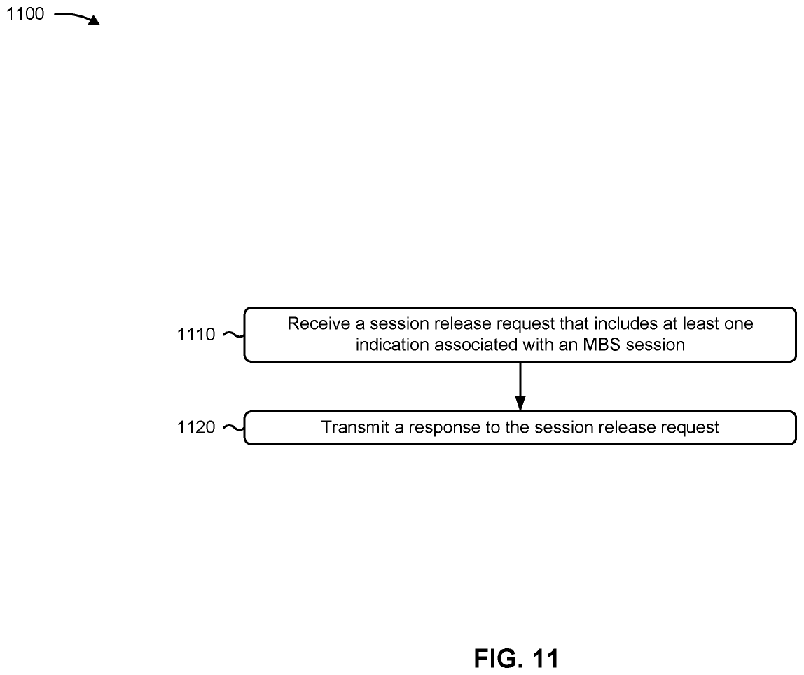

The controller/processor 240 of the network node 110, the controller/processor 280 of the UE 120, and/or any other component(s) of FIG. 2 may perform one or more techniques associated with joining and leaving multicast sessions, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, process 1000 of FIG. 10, process 1100 of FIG. 11, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, process 1000 of FIG. 10, process 1100 of FIG. 11, and/or other processes as described herein. In some examples, executing instructions may include running the instructions, converting the instructions, compiling the instructions, and/or interpreting the instructions, among other examples. In some aspects, network node described herein is the network controller 130, is included in the network controller 130, or includes one or more components of the network controller 130 shown in FIG. 2.

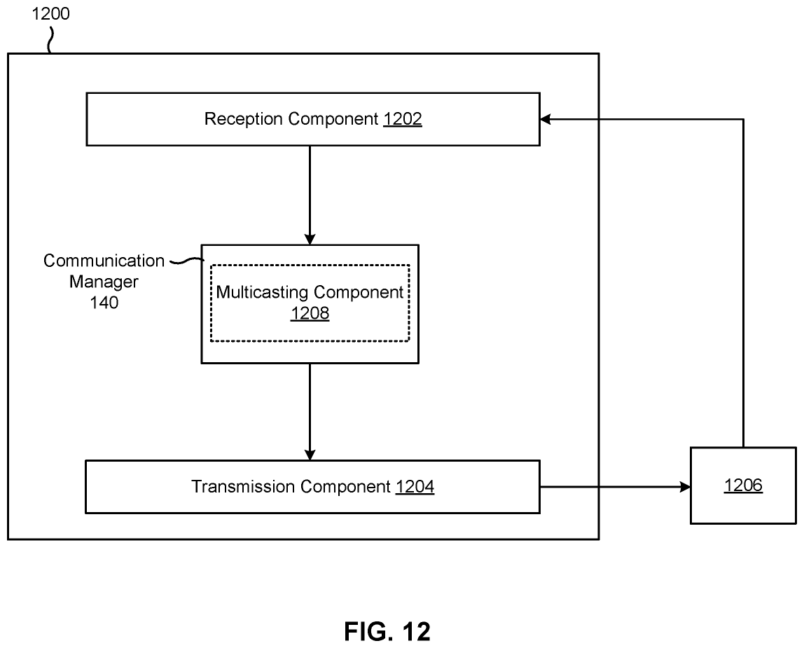

In some aspects, a UE (e.g., the UE 120 and/or apparatus 1200 of FIG. 12) may include means for transmitting, to a mobility function of a core network, a PDU session establishment request that includes at least one indication associated with an MBS session; and/or means for receiving, from a session function of the core network, a response to the PDU session establishment request. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

Additionally, or alternatively, the UE may include means for transmitting, to the session function of the core network, a PDU session release request that includes at least one indication associated with an MBS session; and/or means for receiving, from the session function of the core network, a response to the PDU session release request. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network controller 130 and/or apparatus 1300 of FIG. 12) may include means for receiving, from a UE, a PDU session establishment request that includes at least one indication associated with an MBS session; and/or means for transmitting, to the UE, a response to the PDU session establishment request. In some aspects, the means for the network node to perform operations described herein may include, for example, one or more of communication manager 150, controller/processor 290, memory 292, or communication unit 294. Additionally, or alternatively, the means for the network node to perform operations described herein may include, for example, one or more of transmit processor 220, TX MIMO processor 230, modem 232, antenna 234, MIMO detector 236, receive processor 238, controller/processor 240, memory 242, or scheduler 246.

Additionally, or alternatively, the network node may include means for receiving, from the UE, a PDU session release request that includes at least one indication associated with an MBS session; and/or means for transmitting, to the UE, a response to the PDU session release request. In some aspects, the means for the network node to perform operations described herein may include, for example, one or more of communication manager 150, controller/processor 290, memory 292, or communication unit 294. Additionally, or alternatively, the means for the network node to perform operations described herein may include, for example, one or more of transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

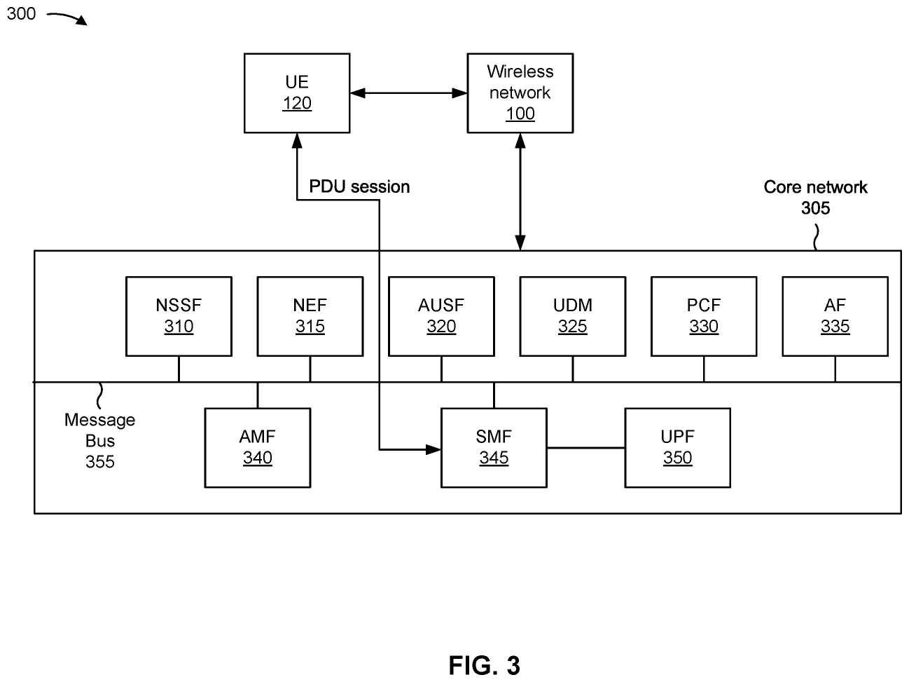

FIG. 3 is a diagram of an example 300 of a core network 305. As shown in FIG. 3, example 300 may include a UE 120, a wireless communication network 100, and a core network 305. Devices and/or networks of example 300 may interconnect via wired connections, wireless connections, or a combination thereof.

The UE 120 may include one or more devices capable of receiving, generating, storing, processing, and/or providing information, such as information described herein. For example, the UE 120 may include a mobile phone (e.g., a smart phone, or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The wireless communication network 100 may support, for example, a cellular RAT. The network 100 may include one or more network nodes (e.g., base transceiver stations, radio base stations, node Bs, eNodeBs (eNBs), gNodeBs (gNBs), base station subsystems, cellular sites, cellular towers, access points, TRPs, radio access nodes, macrocell base stations, microcell base stations, picocell base stations, femtocell base stations, or similar types of devices) and other network entities that can support wireless communication for the UE 120. The network 100 may transfer traffic between the UE 120 (e.g., using a cellular RAT), one or more network nodes (e.g., using a wireless interface or a backhaul interface, such as a wired backhaul interface), and/or the core network 305. The network 100 may provide one or more cells that cover geographic areas.

In some aspects, the network 100 may perform scheduling and/or resource management for the UE 120 covered by the network 100 (e.g., the UE 120 covered by a cell provided by the network 100). In some aspects, the network 100 may be controlled or coordinated by a network controller (e.g., network controller 130 of FIG. 1), which may perform load balancing and network-level configuration. As described above in connection with FIG. 1, the network controller may communicate with the network 100 via a wireless or wireline backhaul. In some aspects, the network 100 may include a network controller, a self-organizing network (SON) module or component, or a similar module or component. Accordingly, the network 100 may perform network control, scheduling, and/or network management functions (e.g., for uplink, downlink, and/or sidelink communications of the UE 120 covered by the network 100).

In some aspects, the core network 305 may include an example functional architecture in which systems and/or methods described herein may be implemented. For example, the core network 305 may include an example architecture of a 5G next generation (NG) core network included in a 5G wireless telecommunications system. Although the example architecture of the core network 305 shown in FIG. 3 may be an example of a service-based architecture, in some aspects, the core network 305 may be implemented as a reference-point architecture, a 4G core network, and/or another type of architecture.

As shown in FIG. 3, the core network 305 may include a number of functional elements. The functional elements may include, for example, a network slice selection function (NSSF) 310, a network exposure function (NEF) 315, an authentication server function (AUSF) 320, a unified data management (UDM) component 325, a policy control function (PCF) 330, an application function (AF) 335, an access and mobility management function (AMF) 340, a session management function (SMF) 345, and a user plane function (UPF) 350, among other examples. These functional elements may be communicatively connected via a message bus 355. Each of the functional elements shown in FIG. 3 may be implemented on one or more devices associated with a wireless telecommunications system. In some implementations, one or more of the functional elements may be implemented on physical devices, such as an access point, a base station, a gateway, and/or another physical device. In some implementations, one or more of the functional elements may be implemented on a computing device of a cloud computing environment.

The NSSF 310 may include one or more devices that select network slice instances for the UE 120. Network slicing is a network architecture model in which logically distinct network slices operate using common network infrastructure. For example, several network slices may operate as isolated end-to-end networks customized to satisfy different target service standards for different types of applications executed, at least in part, by the UE 120 and/or communications to and from the UE 120. Network slicing may efficiently provide communications for different types of services with different service standards.

The NSSF 310 may determine a set of network slice policies to be applied at the network 100. For example, the NSSF 310 may apply one or more UE route selection policy (URSP) rules. In some aspects, the NSSF 310 may select a network slice based on a mapping of a data network name (DNN) field included in a route selection description (RSD) to the DNN field included in a traffic descriptor selected by the UE 120. By providing network slicing, the NSSF 310 allows an operator to deploy multiple substantially independent end-to-end networks potentially with the same infrastructure. In some implementations, each slice may be customized for different services.

The NEF 315 may include one or more devices that support exposure of capabilities and/or events in the wireless telecommunications system to help other entities in the wireless telecommunications system discover network services. The AUSF 320 may include one or more devices that act as an authentication server and support the process of authenticating the UE 120 in the wireless telecommunications system.

The UDM 325 may include one or more devices that store user data and profiles in the wireless telecommunications system. In some aspects, the UDM 325 may be used for fixed access and/or mobile access, in the core network 305.

The PCF 330 may include one or more devices that provide a policy framework that incorporates network slicing, roaming, packet processing, and mobility management. In some aspects, the PCF 330 may include one or more URSP rules used by the NSSF 310 to select network slice instances for the UE 120.

The AF 335 may include one or more devices that support application influence on traffic routing, access to the NEF 315, and policy control. The AMF 340 may include one or more devices that act as a termination point for non-access stratum (NAS) signaling and mobility management. In some aspects, the AMF may request the NSSF 310 to select network slice instances for the UE 120, e.g., at least partially in response to a request for data service from the UE 120.

The SMF 345 may include one or more devices that support the establishment, modification, and release of communication sessions in the wireless telecommunications system. For example, the SMF 345 may configure traffic steering policies at the UPF 350 and enforce user equipment Internet protocol (IP) address allocation and policies. In some aspects, the SMF 345 may provision the network slice instances selected by the NSSF 310 for the UE 120.

As further shown in FIG. 3, the SMF 345 may provide one or more PDU sessions to the UE 120 for transmission of information to the UE 120 (e.g., Internet traffic or delivery of multicast media, such as a streaming service, among other examples). In some aspects, a PDU session may connect the SMF 345 to the UE 120 via the wireless network 100 (e.g., via one or more RUs).

The UPF 350 may include one or more devices that serve as an anchor point for intraRAT and/or interRAT mobility. In some aspects, the UPF 350 may apply rules to packets, such as rules pertaining to packet routing, traffic reporting, and handling user plane QoS, among other examples.

The message bus 355 may be a logical and/or physical communication structure for communication among the functional elements. Accordingly, the message bus 355 may permit communication between two or more functional elements, whether logically (e.g., using one or more application programming interfaces (APIs)) and/or physically (e.g., using one or more wired and/or wireless connections).

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of example 300 may perform one or more functions described as being performed by another set of devices of example environment 300.

As indicated above, FIG. 3 is provided as an example. Other examples may differ from what is described with regard to FIG. 3.

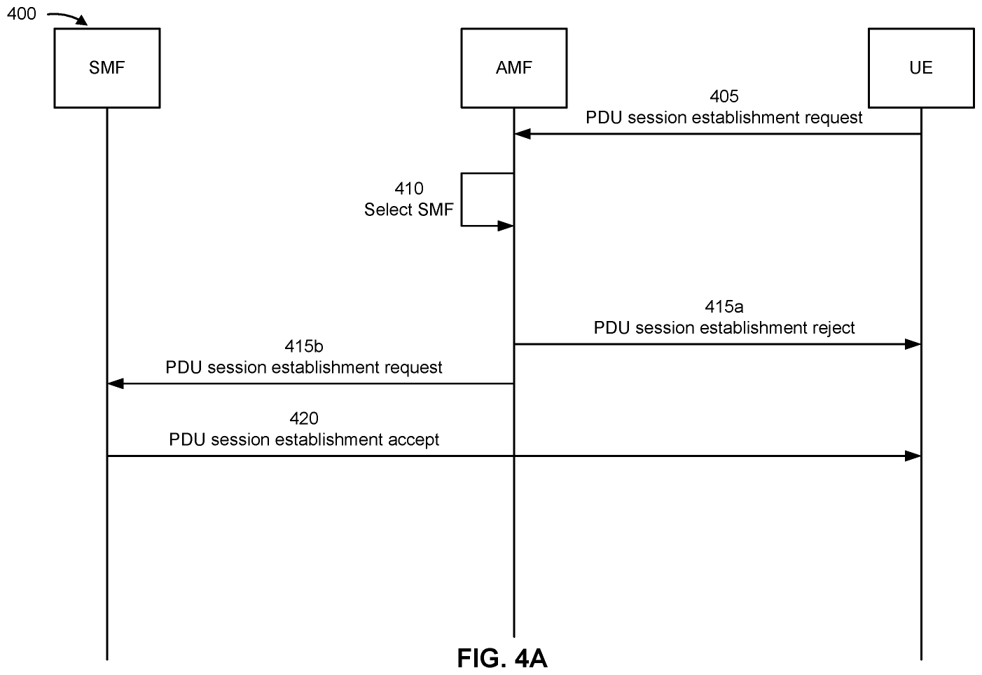

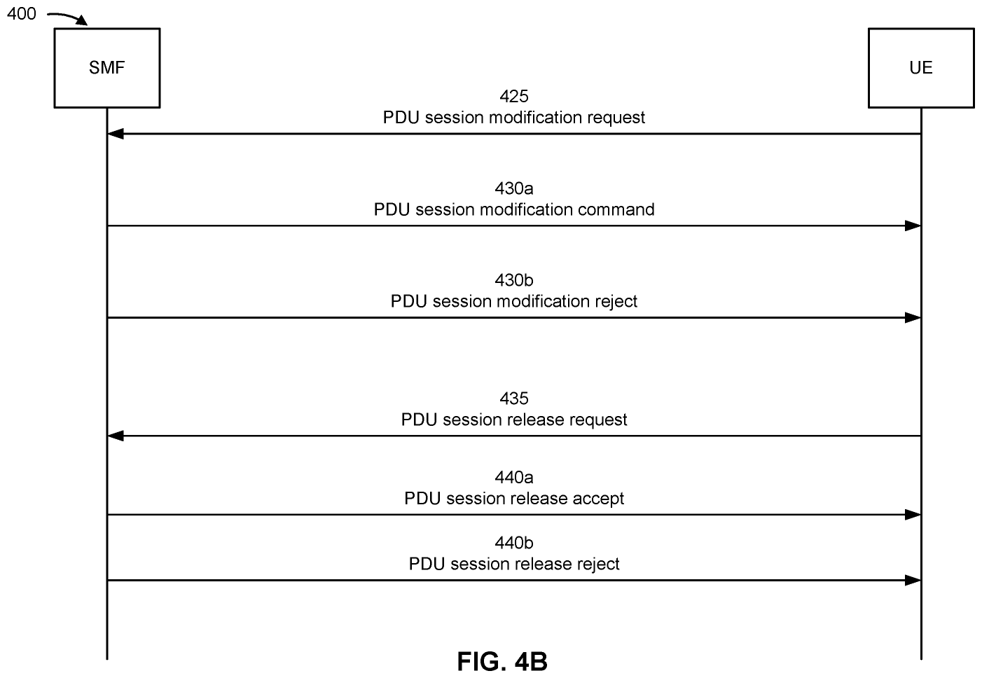

FIGS. 4A and 4B are diagrams illustrating an example 400 of joining a multicast session, in accordance with the present disclosure. As shown in FIGS. 4A and 4B, a UE may communicate with an AMF and an SMF of a core network (e.g., via NAS signaling and/or through an RU of a wireless network).

As shown by reference number 405, the UE may transmit, and the AMF may receive, a PDU session establishment request. The PDU session establishment request may include a DNN associated with a server providing a multicast broadcast service (MBS) session that the UE is trying to join. Accordingly, the AMF may implicitly determine that the UE is requesting the PDU session in order to join the MBS session based on the DNN. However, the DNN may be associated with a server that provides other services in addition to multicast services. Accordingly, the AMF may be unaware that the UE is requesting the PDU session in order to join the MBS session.

When the core network implements network slicing, the PDU session establishment request may include a single network slice service assistance identifier (S-NSSAI) associated with a network slice for the MBS session. Accordingly, the AMF may implicitly determine that the UE is requesting the PDU session in order to join the MBS session based on the S-NSSAI. However, the S-NSSAI may be associated with a network slice used for other services in addition to multicast services. Accordingly, the AMF may be unaware that the UE is requesting the PDU session in order to join the MBS session.

As shown by reference number 410, the AMF may select an SMF to provide a PDU session to the UE. For example, the AMF may select an SMF based on the DNN, the S-NSSAI, and/or another parameter indicated in the PDU session establishment request.

When the AMF is unable to select an SMF to provide a PDU session to the UE, as shown by reference number 415a, the AMF may transmit, and the UE may receive, a PDU session establishment reject. For example, the AMF may be unable to find an SMF to support the server indicated by the DNN and/or to provision services on the network slice indicated by the S-NSSAI, among other examples. The PDU session establishment reject may include a cause value associated with why the AMF could not fulfill the request from the UE. For example, the cause value may be selected from a plurality of possible cause values defined in 3GPP specifications and/or another standard.

When the AMF is able to select an SMF to provide a PDU session to the UE, as shown by reference number 415b, the AMF may forward, and the selected SMF may receive, the PDU session establishment request. Accordingly, as shown by reference number 420, the SMF may transmit, and the UE may receive, a PDU session establishment accept. The PDU session establishment accept may include one or more parameters associated with the PDU session between the UE and the SMF such that the UE may receive and transmit traffic on the PDU session.

As shown in FIG. 4B, in order to join the MBS session, as shown by reference number 425, the UE may transmit, and the SMF may receive, a PDU session modification request. The PDU session modification request may include an identifier associated with the MBS session (e.g., an MBS session ID) as well as an indication that the PDU session modification request is a “join” request. As used herein, “MBS session ID” may include a temporary mobile group identity (TMGI) associated with the MBS session and/or an IP address associated with a source of the MBS session. Accordingly, the SMF may determine whether the PDU session may be provisioned to allow the UE to join the MBS session.

When the SMF is able to provision the PDU session for the MBS session, as shown by reference number 430a, the SMF may transmit, and the UE may receive, a PDU session modification command. The PDU session modification command may include one or more updated parameters associated with the PDU session between the UE and the SMF such that the UE may join the MBS session on the PDU session.

When the SMF is unable to provision the PDU session for the MBS session, as shown by reference number 430b, the SMF may transmit, and the UE may receive, a PDU session modification reject. For example, the SMF may be unable to find information about the MBS session using the MBS session identifier. The PDU session modification reject may include a cause value associated with why the SMF could not fulfill the request from the UE. For example, the cause value may be selected from a plurality of possible cause values defined in 3GPP specifications and/or another standard.

When the UE is unable to use the PDU session to join the MBS session, as shown by reference number 435, the UE may transmit, and the SMF may receive, a PDU session release request. When the SMF is able to release the PDU session, as shown by reference number 440a, the SMF may transmit, and the UE may receive, a PDU session release accept. When the SMF is unable to release the PDU session (e.g., one or more services associated with the UE is using the PDU session), as shown by reference number 440b, the SMF may transmit, and the UE may receive, a PDU session release reject.

Accordingly, joining a multicast session, as described in connection with FIGS. 4A and 4B, is slow and uses significant signaling overhead. This consumes power and processing resources at the UE and at the core network as well as increasing interference for other devices in a same serving cell as the UE or nearby cells.

Some techniques and apparatuses described herein enable a UE (e.g., UE 120) to join a multicast session using one message rather than multiple messages. As a result, the UE 120 experiences reduced latency before joining the multicast session. Additionally, the UE 120 and a core network conserve power and processing resources as well as reducing interference for other devices in a same serving cell as the UE 120 or nearby cells. In some aspects, the UE 120 may additionally use an established PDU session for other traffic (e.g., Internet traffic) even if the UE 120 fails to join the multicast session. As a result, latency associated with other data services on the UE 120 is reduced. Additionally, the UE 120 and the core network conserve power and processing resources.

As indicated above, FIGS. 4A and 4B are provided as an example. Other examples may differ from what is described with respect to FIGS. 4A and 4B.

FIG. 5 is a diagram illustrating an example 500 associated with joining a multicast session, in accordance with the present disclosure. As shown in FIGS. 4A and 4B, a UE may communicate with an AMF 340 and an SMF 345 of a core network (e.g., via NAS signaling and/or through an RU). In some aspects, the AMF 340 and the SMF 345 may be in a 5G network (e.g., a 5G wireless network, such as wireless network 100 of FIG. 1).

As shown by reference number 505, the UE 120 may transmit, and the AMF 340 may receive, a PDU session establishment request that includes at least one indication associated with an MBS session. For example, the PDU session establishment request may include an MBS ID associated with the MBS session that the UE 120 wants to join. In some aspects, the PDU session establishment request may further include DNN associated with the MBS session and/or an S-NSSAI associated with the MBS session.

In some aspects, the PDU session establishment request further includes a join indication. For example, the PDU session establishment request may include a “join” indication as defined in 3GPP specifications and/or another standard. As an alternative, the PDU session establishment request may omit a join indication. Accordingly, the UE 120 may further reduce signaling overhead by omitting the “join” indication.

As shown by reference number 510, the AMF 340 may select an SMF to provide a PDU session to the UE 120. For example, the AMF 340 may select the SMF 345 based on the DNN, the S-NSSAI, and/or another parameter indicated in the PDU session establishment request. The AMF 340 may not select an SMF that does not support multicast services because the PDU session establishment request includes the MBS session ID. Accordingly, the AMF 340 reduces chances of wasting power, processing resources, and signaling overhead by selecting an SMF that cannot support the MBS session.

When the AMF 340 is unable to select an SMF to provide a PDU session to the UE 120, as shown by reference number 515a, the AMF 340 may transmit, and the UE 120 may receive, a PDU session establishment reject. For example, the AMF 340 may be unable to find an SMF to support the server indicated by the DNN, to provision services on the network slice indicated by the S-NSSAI, and/or to support multicasting services based on the MBS session ID, among other examples. The PDU session establishment reject may include a cause value associated with why the AMF 340 could not fulfill the request from the UE 120. For example, the cause value may be selected from a plurality of possible cause values defined in 3GPP specifications and/or another standard.

When the AMF 340 is able to select the SMF 345 to provide a PDU session to the UE 120, as shown by reference number 515b, the AMF 340 may forward, and the selected SMF 345 may receive, the PDU session establishment request.

Accordingly, when the SMF 345 is able to provision a PDU session to the UE 120 for the MBS session, as shown by reference number 520a, the SMF 345 may transmit, and the UE 120 may receive, a PDU session establishment accept. The PDU session establishment accept may include one or more parameters associated with the PDU session between the UE 120 and the SMF 345 such that the UE may receive and transmit traffic on the PDU session. The PDU session establishment accept may indicate establishment of the PDU session with the UE 120 and acceptance of a request from the UE 120 to join the MBS session.

In some aspects, the SMF 345 is unable to provision a PDU session to the UE 120 for the MBS session. For example, the SMF 345 may be unable to find information about the MBS session using the MBS session ID.

When the SMF 345 is unable to provision a PDU session to the UE 120 for the MBS session, as shown by reference number 520b, the SMF 345 may determine whether to provide establishment of the PDU session with rejection of the request to join the MBS session.

In some aspects, the UE 120 may transmit the PDU session establishment request with an indication whether the PDU session is only intended for multicast sessions. For example, the UE 120 may include a Boolean, a bit, and/or another indication in the PDU session establishment request indicating whether the UE 120 will use a PDU session with the SMF 345 even if the UE 120 is unable to join the MBS session. Accordingly, the SMF 345 may determine whether to provide establishment of the PDU session based on the indication.

Additionally, or alternatively, the SMF 345 may determine whether to provide establishment of the PDU session with rejection of the request to join the MBS session based one or more contextual factors associated with the UE 120. For example, the SMF 345 may determine to provide establishment of the PDU session when the UE 120 is not associated with an existing PDU session from the SMF 345 and/or another SMF associated with the AMF 340. Similarly, the SMF 345 may determine not to provide establishment of the PDU session when the UE 120 is associated with one or more existing PDU sessions from the SMF 345 and/or another SMF associated with the AMF 340.

In some aspects, the SMF 345 may perform a default action (e.g., rejecting the PDU session by default or establishing the PDU session by default). The default action may be overridden by an indication in the PDU session establishment request. Additionally, or alternatively, the default action may be overridden when an operator associated with the SMF 345 modifies a setting such that the SMF 345 performs a determination as described above in lieu of performing the default action.

When the SMF 345 determines to establish the PDU session, as shown by reference number 525a, the SMF 345 may transmit, and the UE 120 may receive, a PDU session establishment accept. The PDU session establishment accept may include a cause value associated with establishment of the PDU session with the UE 120 and rejection of a request from the UE 120 to join the MBS session.

When the SMF 345 determines not to establish the PDU session, as shown by reference number 525b, the SMF may transmit, and the UE 120 may receive, a PDU session establishment reject. The PDU session establishment reject may include a cause value associated with why the SMF 345 could not fulfill the request from the UE. For example, the cause value may be selected from a plurality of possible cause values defined in 3GPP specifications and/or another standard. Additionally, or alternatively, the cause value may include a new cause value associated with why the SMF 345 rejected a request from the UE 120 to join the MBS session.

By using techniques as described in connection with FIG. 5, the UE 120 may join a multicast session using one message rather than multiple messages. As a result, the UE 120 experiences reduced latency before joining the multicast session. Additionally, the UE 120 and the core network (including the AMF 340 and the SMF 345) conserve power and processing resources as well as reducing interference for other devices in a same serving cell as the UE 120 or nearby cells. In some aspects, the UE 120 may additionally use an established PDU session for other traffic (e.g., as described in connection with reference number 520b) even if the UE 120 fails to join the multicast session. As a result, latency associated with other data services on the UE 120 is reduced. Additionally, the UE 120 and the core network conserve power and processing resources.

As indicated above, FIG. 5 is provided as an example. Other examples may differ from what is described with respect to FIG. 5.

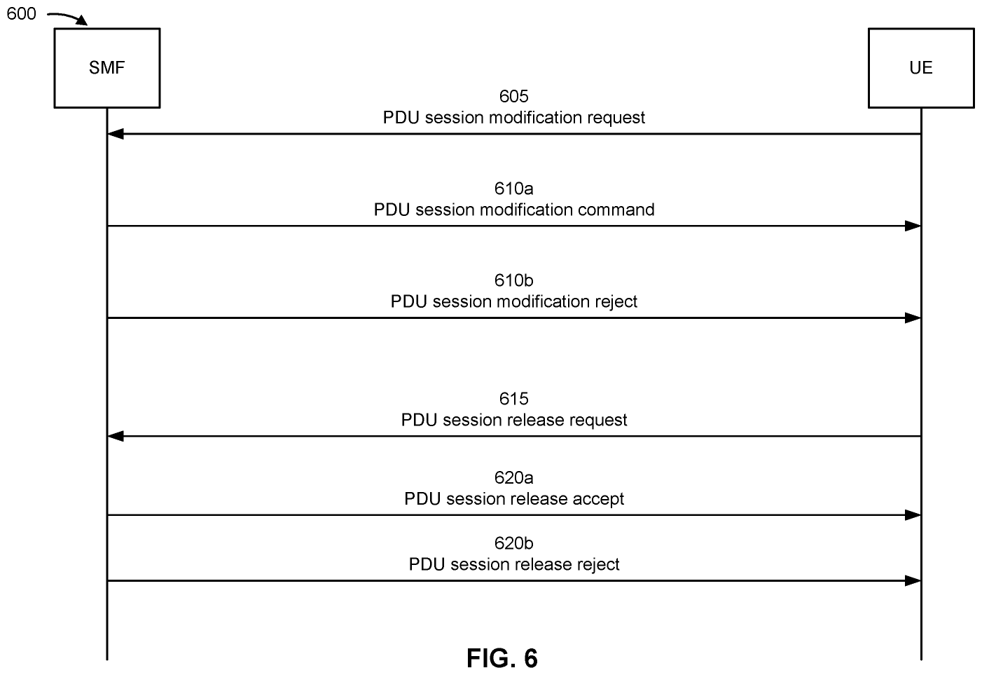

FIG. 6 is a diagram illustrating an example 600 of leaving a multicast session, in accordance with the present disclosure. As shown in FIG. 6, a UE may communicate with an SMF of a core network (e.g., via NAS signaling and/or through an RU of a wireless network).

The UE may be part of a multicast session. For example, the UE may be receiving traffic from an MBS session through the SMF. The UE may have joined the multicast session as described in connection with FIGS. 4A and 4B or in connection with FIG. 5.

As shown in FIG. 6, in order to leave the MBS session, as shown by reference number 605, the UE may transmit, and the SMF may receive, a PDU session modification request. The PDU session modification request may include an identifier associated with the MBS session (e.g., an MBS session ID) as well as an indication that the PDU session modification request is a “leave” request. Accordingly, the SMF may determine whether the UE may leave the MBS session.

When the UE is able to leave the MBS session, as shown by reference number 610a, the SMF may transmit, and the UE may receive, a PDU session modification command. The PDU session modification command may include one or more updated parameters associated with the PDU session between the UE and the SMF such that the UE may stop receive traffic, associated with the MBS session, on the PDU session. When the UE is unable to leave the MBS session, as shown by reference number 610b, the SMF may transmit, and the UE may receive, a PDU session modification reject.

After the UE leaves the MBS session, as shown by reference number 615, the UE may transmit, and the SMF may receive, a PDU session release request. When the SMF is able to release the PDU session, as shown by reference number 620a, the SMF may transmit, and the UE may receive, a PDU session release accept. When the SMF is unable to release the PDU session (e.g., one or more services associated with the UE is using the PDU session), as shown by reference number 620b, the SMF may transmit, and the UE may receive, a PDU session release reject.

Accordingly, leaving a multicast session, as described in connection with FIG. 6, is slow and uses significant signaling overhead. This consumes power and processing resources at the UE and at the core network as well as increasing interference for other devices in a same serving cell as the UE or nearby cells.

Some techniques and apparatuses described herein enable a UE (e.g., UE 120) to leave a multicast session using one message rather than multiple messages. As a result, the UE 120 experiences reduced latency before leaving the multicast session. Additionally, the UE 120 and a core network conserve power and processing resources as well as reducing interference for other devices in a same serving cell as the UE 120 or nearby cells.

As indicated above, FIG. 6 is provided as an example. Other examples may differ from what is described with respect to FIG. 6.

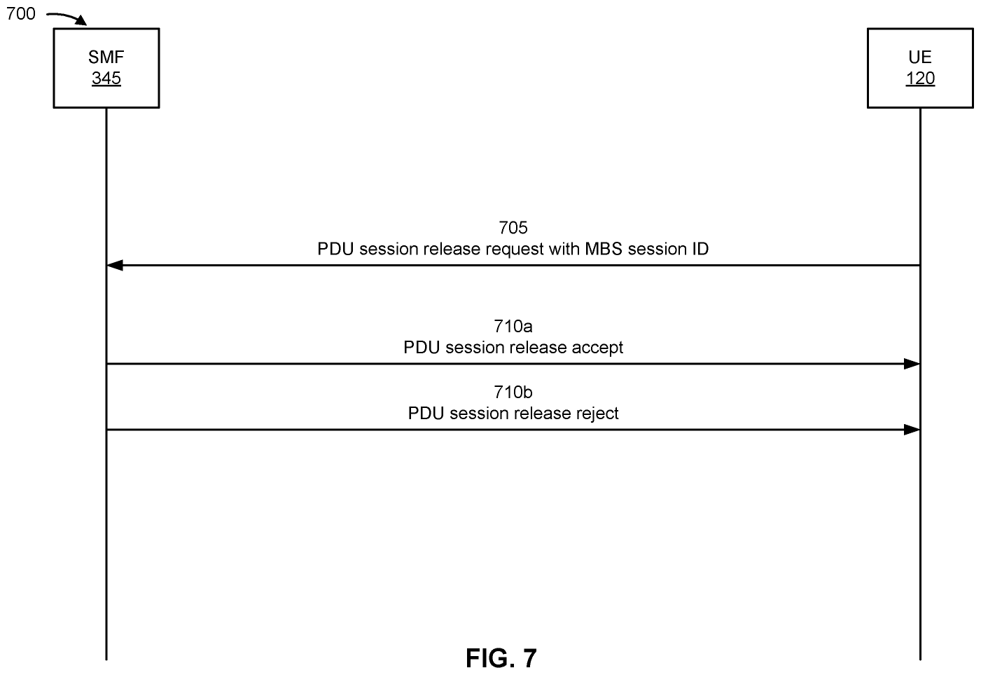

FIG. 7 is a diagram illustrating an example 700 associated with leaving a multicast session, in accordance with the present disclosure. As shown in FIG. 7, a UE may communicate with an SMF 345 of a core network (e.g., via NAS signaling and/or through an RU of a wireless network). In some aspects, the SMF 345 may be in a 5G network (e.g., a 5G wireless network, such as wireless network 100 of FIG. 1).

The UE may be part of a multicast session. For example, the UE 120 may be receiving traffic from an MBS session through the SMF 345. The UE 120 may have joined the multicast session as described in connection with FIGS. 4A and 4B or in connection with FIG. 5.

As shown in FIG. 7, in order to leave the MBS session, as shown by reference number 705, the UE 120 may transmit, and the SMF 345 may receive, a PDU session release request that includes at least one indication associated with an MBS session. For example, the PDU session release request may include an MBS ID associated with the MBS session that the UE 120 wants to leave. In some aspects, the PDU session release request may further include DNN associated with the MBS session and/or an S-NSSAI associated with the MBS session.

In some aspects, the PDU session release request further includes a leave indication. For example, the PDU session release request may include a “leave” indication as defined in 3GPP specifications and/or another standard. As an alternative, the PDU session release request may omit a leave indication. Accordingly, the UE 120 may further reduce signaling overhead by omitting the “leave” indication.

Accordingly, the SMF 345 may determine whether the UE 120 may leave the MBS session. When the UE 120 is able to leave the MBS session, the SMF 345 may determine whether the PDU session may be released. When the SMF 345 is able to release the PDU session, as shown by reference number 710a, the SMF 345 may transmit, and the UE 120 may receive, a PDU session release accept.

When the UE 120 is unable to leave the MBS session, as shown by reference number 710b, the SMF 345 may transmit, and the UE 120 may receive, a PDU session release reject. The PDU session release reject may include a cause value associated with why the SMF 345 could not fulfill the request from the UE. For example, the cause value may include a new cause value associated with why the SMF 345 rejected a request from the UE 120 to leave the MBS session.

When the SMF 345 is unable to release the PDU session (e.g., one or more services associated with the UE 120 is using the PDU session), as shown by reference number 710b, the SMF may transmit, and the UE may receive, a PDU session release reject. The PDU session release reject may include a cause value associated with why the SMF 345 could not fulfill the request from the UE. For example, the cause value may be selected from a plurality of possible cause values, associated with why the SMF 345 rejected a request from the UE 120 to release the PDU session, defined in 3GPP specifications and/or another standard.

By using techniques as described in connection with FIG. 7, the UE 120 may leave a multicast session using one message rather than multiple messages. As a result, the UE 120 experiences reduced latency before leaving the multicast session. Additionally, the UE 120 and the core network (including the SMF 345) conserve power and processing resources as well as reducing interference for other devices in a same serving cell as the UE 120 or nearby cells.

As indicated above, FIG. 7 is provided as an example. Other examples may differ from what is described with respect to FIG. 7.

FIG. 8 is a diagram illustrating an example process 800 performed, for example, by a UE, in accordance with the present disclosure. Example process 800 is an example where the UE (e.g., UE 120 and/or apparatus 1200 of FIG. 12) performs operations associated with joining and leaving multicast sessions.

As shown in FIG. 8, in some aspects, process 800 may include transmitting a session establishment request that includes at least one indication associated with an MBS session (block 810). For example, the UE (e.g., using communication manager 140 and/or transmission component 1204, depicted in FIG. 12) may transmit a session establishment request that includes at least one indication associated with an MBS session, as described herein.

As further shown in FIG. 8, in some aspects, process 800 may include receiving a response to the session establishment request (block 820). For example, the UE (e.g., using communication manager 140 and/or reception component 1202, depicted in FIG. 12) may receive a response to the session establishment request, as described herein.

Process 800 may include additional aspects, such as any single aspect or any combination of aspects described below and/or in connection with one or more other processes described elsewhere herein.

In a first aspect, the session establishment request includes a PDU session establishment request.

In a second aspect, alone or in combination with the first aspect, the at least one indication includes a request to join the MBS session.

In a third aspect, alone or in combination with one or more of the first and second aspects, the at least one indication includes an identity associated with the MBS session.

In a fourth aspect, alone or in combination with one or more of the first through third aspects, the identity associated with the MBS session includes a TMGI associated with the MBS session, an IP address associated with a source of the MBS session, or a combination thereof.

In a fifth aspect, alone or in combination with one or more of the first through fourth aspects, the response includes a PDU session establishment reject.

In a sixth aspect, alone or in combination with one or more of the first through fifth aspects, the response includes a PDU session establishment accept.

In a seventh aspect, alone or in combination with one or more of the first through sixth aspects, the response indicates acceptance of a request to establish a PDU session and includes a cause value associated with rejection of a request to join the MBS session.

In an eighth aspect, alone or in combination with one or more of the first through seventh aspects, the response indicates acceptance of a request for establishment of a PDU session and acceptance of a request to join the MBS session.

In a ninth aspect, alone or in combination with one or more of the first through eighth aspects, the network includes an SMF, the request is transmitted to the SMF, and the response is received from the SMF.

In a tenth aspect, alone or in combination with one or more of the first through ninth aspects, the session establishment request includes an indication whether a PDU session is only intended for multicast sessions.

In an eleventh aspect, alone or in combination with one or more of the first through ninth aspects, process 800 further includes determining (e.g., using communication manager 140 and/or multicasting component 1208, depicted in FIG. 12) whether the PDU session is only intended for multicast sessions, such that the indication included in the session establishment request is based on the determination.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

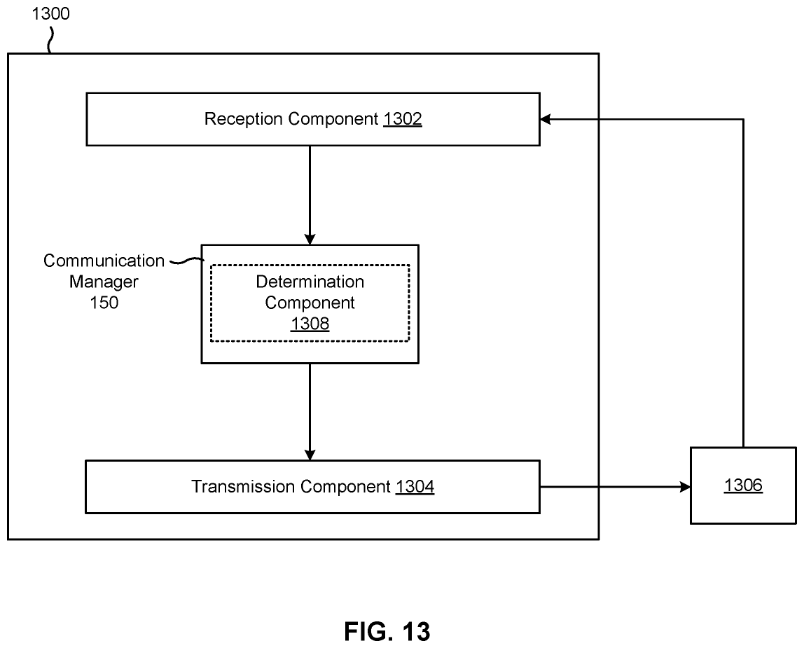

FIG. 9 is a diagram illustrating an example process 900 performed, for example, by a network node, in accordance with the present disclosure. Example process 900 is an example where the network node (e.g., network controller 130 and/or apparatus 1300 of FIG. 13) performs operations associated with joining multicast sessions.

As shown in FIG. 9, in some aspects, process 900 may include receiving a session establishment request that includes at least one indication associated with an MBS session (block 910). For example, the network node (e.g., using communication manager 150 and/or reception component 1302, depicted in FIG. 13) may receive a session establishment request that includes at least one indication associated with an MBS session, as described herein.

As further shown in FIG. 9, in some aspects, process 900 may include transmitting a response to the session establishment request (block 920). For example, the network node (e.g., using communication manager 150 and/or transmission component 1304, depicted in FIG. 13) may transmit a response to the session establishment request, as described herein.

Process 900 may include additional aspects, such as any single aspect or any combination of aspects described below and/or in connection with one or more other processes described elsewhere herein.

In a first aspect, the session establishment request includes a PDU session establishment request.

In a second aspect, alone or in combination with the first aspect, the at least one indication includes a request to join the MBS session.

In a third aspect, alone or in combination with one or more of the first and second aspects, the at least one indication includes an identity associated with the MBS session.

In a fourth aspect, alone or in combination with one or more of the first through third aspects, the identity associated with the MBS session includes a TMGI associated with the MBS session, an IP address associated with a source of the MBS session, or a combination thereof.

In a fifth aspect, alone or in combination with one or more of the first through fourth aspects, the response includes a PDU session establishment reject.

In a sixth aspect, alone or in combination with one or more of the first through fifth aspects, the response includes a PDU session establishment accept.

In a seventh aspect, alone or in combination with one or more of the first through sixth aspects, the response indicates acceptance of a request to establish a PDU session and includes a cause value associated with rejection of a request to join the MBS session.

In an eighth aspect, alone or in combination with one or more of the first through seventh aspects, process 900 includes determining (e.g., using communication manager 150 and/or determination component 1308, depicted in FIG. 13) to provide establishment of the PDU session with rejection of the request to join the MBS session.

In a ninth aspect, alone or in combination with one or more of the first through eighth aspects, the session establishment request includes an indication whether the PDU session is only intended for multicast sessions, and the determination is based on the indication.

In a tenth aspect, alone or in combination with one or more of the first through ninth aspects, the response indicates acceptance of a request for establishment of a PDU session and acceptance of a request to join the MBS session.

In an eleventh aspect, alone or in combination with one or more of the first through tenth aspects, the network node is included in an SMF, the request is received at the SMF, and the response is generated by the SMF.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a UE, in accordance with the present disclosure. Example process 1000 is an example where the UE (e.g., UE 120 and/or apparatus 1200 of FIG. 12) performs operations associated with leaving multicast sessions.

As shown in FIG. 10, in some aspects, process 1000 may include transmitting a session release request that includes at least one indication associated with an MBS session (block 1010). For example, the UE (e.g., using communication manager 140 and/or transmission component 1204, depicted in FIG. 12) may transmit a session release request that includes at least one indication associated with an MBS session, as described herein.

As further shown in FIG. 10, in some aspects, process 1000 may include receiving a response to the session release request (block 1020). For example, the UE (e.g., using communication manager 140 and/or reception component 1202, depicted in FIG. 12) may receive a response to the session release request, as described herein.

Process 1000 may include additional aspects, such as any single aspect or any combination of aspects described below and/or in connection with one or more other processes described elsewhere herein.

In a first aspect, the session release request includes a PDU session release request.

In a second aspect, alone or in combination with the first aspect, the at least one indication includes a request to leave the MBS session.

In a third aspect, alone or in combination with one or more of the first and second aspects, the at least one indication includes an identity associated with the MBS session.

In a fourth aspect, alone or in combination with one or more of the first through third aspects, the identity associated with the MBS session includes a TMGI associated with the MBS session, an IP address associated with a source of the MBS session, or a combination thereof.

In a fifth aspect, alone or in combination with one or more of the first through fourth aspects, the response includes a PDU session release accept.

In a sixth aspect, alone or in combination with one or more of the first through fifth aspects, the response includes a PDU session release reject.

In a seventh aspect, alone or in combination with one or more of the first through sixth aspects, the response includes a cause value associated with rejection of a request to leave the MBS session.

In an eighth aspect, alone or in combination with one or more of the first through seventh aspects, the response includes a cause value associated with rejection of a request to release a PDU session.

In a ninth aspect, alone or in combination with one or more of the first through eighth aspects, the network includes an SMF, the request is transmitted to the SMF, and the response is received from the SMF.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network node, in accordance with the present disclosure. Example process 1100 is an example where the network node (e.g., network controller 130 and/or apparatus 1300 of FIG. 13) performs operations associated with leaving multicast sessions.

As shown in FIG. 11, in some aspects, process 1100 may include receiving a session release request that includes at least one indication associated with an MBS session (block 1110). For example, the network node (e.g., using communication manager 150 and/or reception component 1302, depicted in FIG. 13) may receive a session release request that includes at least one indication associated with an MBS session, as described herein.

As further shown in FIG. 11, in some aspects, process 1100 may include transmitting a response to the session release request (block 1120). For example, the network node (e.g., using communication manager 150 and/or transmission component 1304, depicted in FIG. 13) may transmit a response to the session release request, as described herein.

Process 1100 may include additional aspects, such as any single aspect or any combination of aspects described below and/or in connection with one or more other processes described elsewhere herein.

In a first aspect, the session release request includes a PDU session release request.

In a second aspect, alone or in combination with the first aspect, the at least one indication includes a request to leave the MBS session.

In a third aspect, alone or in combination with one or more of the first and second aspects, the at least one indication includes an identity associated with the MBS session.

In a fourth aspect, alone or in combination with one or more of the first through third aspects, the identity associated with the MBS session includes a TMGI associated with the MBS session, an IP address associated with a source of the MBS session, or a combination thereof.

In a fifth aspect, alone or in combination with one or more of the first through fourth aspects, the response includes a PDU session release accept.

In a sixth aspect, alone or in combination with one or more of the first through fifth aspects, the response includes a PDU session release reject.

In a seventh aspect, alone or in combination with one or more of the first through sixth aspects, the response includes a cause value associated with rejection of a request to leave the MBS session.

In an eighth aspect, alone or in combination with one or more of the first through seventh aspects, the response includes a cause value associated with rejection of a request to release a PDU session.

In a ninth aspect, alone or in combination with one or more of the first through eighth aspects, the network node is included in an SMF, the request is received at the SMF, and the response is generated by the SMF.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication. The apparatus 1200 may be a UE, or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, an RU, or another wireless communication device) using the reception component 1202 and the transmission component 1204. As further shown, the apparatus 1200 may include the communication manager 140. The communication manager 140 may include a multicasting component 1208, among other examples.

In some aspects, the apparatus 1200 may be configured to perform one or more operations described herein in connection with FIGS. 5 and/or 7. Additionally, or alternatively, the apparatus 1200 may be configured to perform one or more processes described herein, such as process 800 of FIG. 8, process 1000 of FIG. 10, or a combination thereof. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

In some aspects, the transmission component 1204 may transmit (e.g., to a core network, such as AMF 340 and/or SMF 345 of core network 305) a session establishment request that includes at least one indication associated with an MBS session. For example, the multicasting component 1208 may determine an MBS session ID associated with the MBS session that the apparatus 1200 is trying to join. The multicasting component 1208 may include a MIMO detector, a receive processor, a controller/processor, a memory, or a combination thereof, of the UE described in connection with FIG. 2. The reception component 1202 may thus receive (e.g., from the core network, such as SMF 345 of core network 305) a response to the session establishment request. In some aspects, the multicasting component 1208 may determine whether the PDU session is only intended for multicast sessions such that the transmission component 1204 includes an indication in the session establishment request whether the PDU session is only intended for multicast sessions.

Additionally, or alternatively, the transmission component 1204 may transmit (e.g., to the core network, such as SMF 345 of core network 305) a session release request that includes at least one indication associated with an MBS session. For example, the multicasting component 1208 may determine an MBS session ID associated with the MBS session that the apparatus 1200 is trying to leave. The reception component 1202 may thus receive (e.g., from the core network, such as SMF 345 of core network 305) a response to the session release request.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication. The apparatus 1300 may be a network node, or a network node may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, an RU, or another wireless communication device) using the reception component 1302 and the transmission component 1304. As further shown, the apparatus 1300 may include the communication manager 150. The communication manager 150 may include a determination component 1308, among other examples.

In some aspects, the apparatus 1300 may be configured to perform one or more operations described herein in connection with FIGS. 5 and/or 7. Additionally, or alternatively, the apparatus 1300 may be configured to perform one or more processes described herein, such as process 900 of FIG. 9, process 1100 of FIG. 11, or a combination thereof. In some aspects, the apparatus 1300 and/or one or more components shown in FIG. 13 may include one or more components of the network controller described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include a communication unit, a controller/processor, a memory, or a combination thereof, of the network controller described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include a communication unit, a controller/processor, a memory, or a combination thereof, of the network controller described in connection with FIG. 2. In some aspects, the transmission component 1304 may be co-located with the reception component 1302 in a transceiver.

In some aspects, the reception component 1302 may receive (e.g., from the apparatus 1306, such as a UE) a session establishment request that includes at least one indication associated with an MBS session. Accordingly, the transmission component 1304 may transmit (e.g., to the apparatus 1306) a response to the session establishment request. In some aspects, the determination component 1308 may determine to provide establishment of a PDU session with rejection of the request to join the MBS session. Accordingly, the response may indicate establishment of a PDU session and rejection of a request to join the MBS session. The determination component 1308 may include a controller/processor, a memory, or a combination thereof, of the network controller described in connection with FIG. 2.

Additionally, or alternatively, the reception component 1302 may receive (e.g., from the apparatus 1306, such as a UE) a session release request that includes at least one indication associated with an MBS session. Accordingly, the transmission component 1304 may transmit (e.g., to the apparatus 1306) a response to the session release request.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a user equipment (UE), comprising: transmitting, to a network, a session establishment request that includes at least one indication associated with a multicast broadcast service (MBS) session; and receiving, from the network, a response to the session establishment request.

Aspect 2: The method of Aspect 1, wherein the session establishment request comprises a protocol data unit (PDU) session establishment request.

Aspect 3: The method of any of Aspects 1 through 2, wherein the at least one indication includes a request to join the MBS session.

Aspect 4: The method of any of Aspects 1 through 3, wherein the at least one indication comprises an identity associated with the MBS session.

Aspect 5: The method of Aspect 4, wherein the identity associated with the MBS session includes a temporary mobile group identity (TMGI) associated with the MBS session, an Internet protocol (IP) address associated with a source of the MBS session, or a combination thereof.

Aspect 6: The method of any of Aspects 1 through 5, wherein the response comprises a protocol data unit (PDU) session establishment reject.

Aspect 7: The method of any of Aspects 1 through 5, wherein the response comprises a protocol data unit (PDU) session establishment accept.

Aspect 8: The method of Aspect 7, wherein the response indicates acceptance of a request to establish a PDU session and includes a cause value associated with rejection of a request to join the MBS session.

Aspect 9: The method of Aspect 7, wherein the response indicates acceptance of a request for establishment of a PDU session and acceptance of a request to join the MBS session.

Aspect 10: The method of any of Aspects 1 through 9, wherein the network comprises a session management function (SMF), the request is transmitted to the SMF, and the response is received from the SMF.

Aspect 11: The method of any of Aspects 1 through 10, wherein the session establishment request includes an indication whether a protocol data unit (PDU) session is only intended for multicast sessions.

Aspect 12: The method of Aspect 11, further comprising: determining whether the PDU session is only intended for multicast sessions, wherein the indication included in the session establishment request is based on the determination.

Aspect 13: A method of wireless communication performed by a network node, comprising: receiving, from a user equipment (UE), a session establishment request that includes at least one indication associated with a multicast broadcast service (MBS) session; and transmitting, to the UE, a response to the session establishment request.

Aspect 14: The method of Aspect 13, wherein the session establishment request comprises a protocol data unit (PDU) session establishment request.

Aspect 15: The method of any of Aspects 13 through 14, wherein the at least one indication includes a request to join the MBS session.

Aspect 16: The method of any of Aspects 13 through 15, wherein the at least one indication comprises an identity associated with the MBS session.

Aspect 17: The method of Aspect 16, wherein the identity associated with the MBS session includes a temporary mobile group identity (TMGI) associated with the MBS session, an Internet protocol (IP) address associated with a source of the MBS session, or a combination thereof.

Aspect 18: The method of any of Aspects 13 through 17, wherein the response comprises a protocol data unit (PDU) session establishment reject.

Aspect 19: The method of any of Aspects 13 through 17, wherein the response comprises a protocol data unit (PDU) session establishment accept.

Aspect 20: The method of Aspect 19, wherein the response indicates acceptance of a request to establish a PDU session and includes a cause value associated with rejection of a request to join the MBS session.

Aspect 21: The method of Aspect 20, further comprising: determining to provide establishment of the PDU session with rejection of the request to join the MBS session.

Aspect 22: The method of Aspect 21, wherein the session establishment request includes an indication whether the PDU session is only intended for multicast sessions, wherein the determination is based on the indication.

Aspect 23: The method of Aspect 19, wherein the response indicates acceptance of a request for establishment of a PDU session and acceptance of a request to join the MBS session.

Aspect 24: The method of any of Aspects 13 through 23, wherein the network node is included in a session management function (SMF), the request is received at the SMF, and the response is generated by the SMF.

Aspect 25: A method of wireless communication performed by a user equipment (UE), comprising: transmitting, to a network, a session release request that includes at least one indication associated with a multicast broadcast service (MBS) session; and receiving, from the network, a response to the session release request.

Aspect 26: The method of Aspect 25, wherein the session release request comprises a protocol data unit (PDU) session release request.

Aspect 27: The method of any of Aspects 25 through 26, wherein the at least one indication includes a request to leave the MBS session.

Aspect 28: The method of any of Aspects 25 through 27, wherein the at least one indication comprises an identity associated with the MBS session.

Aspect 29: The method of Aspect 28, wherein the identity associated with the MBS session includes a temporary mobile group identity (TMGI) associated with the MBS session, an Internet protocol (IP) address associated with a source of the MBS session, or a combination thereof.

Aspect 30: The method of any of Aspects 25 through 29, wherein the response comprises a protocol data unit (PDU) session release accept.

Aspect 31: The method of any of Aspects 25 through 29, wherein the response comprises a protocol data unit (PDU) session release reject.

Aspect 32: The method of Aspect 31, wherein the response includes a cause value associated with rejection of a request to leave the MBS session.

Aspect 33: The method of Aspect 31, wherein the response includes a cause value associated with rejection of a request to release a PDU session.

Aspect 34: The method of any of Aspects 25 through 33, wherein the network comprises a session management function (SMF), the request is transmitted to the SMF, and the response is received from the SMF.

Aspect 35: A method of wireless communication performed by a network node, comprising: receiving, from a user equipment (UE), a session release request that includes at least one indication associated with a multicast broadcast service (MBS) session; and transmitting, to the UE, a response to the session release request.

Aspect 36: The method of Aspect 35, wherein the session release request comprises a protocol data unit (PDU) session release request.

Aspect 37: The method of any of Aspects 35 through 36, wherein the at least one indication includes a request to leave the MBS session.

Aspect 38: The method of any of Aspects 35 through 37, wherein the at least one indication comprises an identity associated with the MBS session.

Aspect 39: The method of Aspect 38, wherein the identity associated with the MBS session includes a temporary mobile group identity (TMGI) associated with the MBS session, an Internet protocol (IP) address associated with a source of the MBS session, or a combination thereof.

Aspect 40: The method of any of Aspects 35 through 39, wherein the response comprises a protocol data unit (PDU) session release accept.

Aspect 41: The method of any of Aspects 35 through 39, wherein the response comprises a protocol data unit (PDU) session release reject.

Aspect 42: The method of Aspect 41, wherein the response includes a cause value associated with rejection of a request to leave the MBS session.

Aspect 43: The method of Aspect 41, wherein the response includes a cause value associated with rejection of a request to release a PDU session.

Aspect 44: The method of any of Aspects 35 through 43, wherein the network node is included in a session management function (SMF), the request is received at the SMF, and the response is generated by the SMF.

Aspect 45: An apparatus for wireless communication at a device, comprising a processor; memory coupled with the processor; and instructions stored in the memory and executable by the processor to cause the apparatus to perform the method of one or more of Aspects 1-12.

Aspect 46: A device for wireless communication, comprising a memory and one or more processors coupled to the memory, the one or more processors configured to perform the method of one or more of Aspects 1-12.

Aspect 47: An apparatus for wireless communication, comprising at least one means for performing the method of one or more of Aspects 1-12.

Aspect 48: A non-transitory computer-readable medium storing code for wireless communication, the code comprising instructions executable by a processor to perform the method of one or more of Aspects 1-12.

Aspect 49: A non-transitory computer-readable medium storing a set of instructions for wireless communication, the set of instructions comprising one or more instructions that, when executed by one or more processors of a device, cause the device to perform the method of one or more of Aspects 1-12.

Aspect 50: An apparatus for wireless communication at a device, comprising a processor; memory coupled with the processor; and instructions stored in the memory and executable by the processor to cause the apparatus to perform the method of one or more of Aspects 13-24.

Aspect 51: A device for wireless communication, comprising a memory and one or more processors coupled to the memory, the one or more processors configured to perform the method of one or more of Aspects 13-24.

Aspect 52: An apparatus for wireless communication, comprising at least one means for performing the method of one or more of Aspects 13-24.

Aspect 53: A non-transitory computer-readable medium storing code for wireless communication, the code comprising instructions executable by a processor to perform the method of one or more of Aspects 13-24.

Aspect 54: A non-transitory computer-readable medium storing a set of instructions for wireless communication, the set of instructions comprising one or more instructions that, when executed by one or more processors of a device, cause the device to perform the method of one or more of Aspects 13-24.

Aspect 55: An apparatus for wireless communication at a device, comprising a processor; memory coupled with the processor; and instructions stored in the memory and executable by the processor to cause the apparatus to perform the method of one or more of Aspects 25-34.

Aspect 56: A device for wireless communication, comprising a memory and one or more processors coupled to the memory, the one or more processors configured to perform the method of one or more of Aspects 25-34.

Aspect 57: An apparatus for wireless communication, comprising at least one means for performing the method of one or more of Aspects 25-34.

Aspect 58: A non-transitory computer-readable medium storing code for wireless communication, the code comprising instructions executable by a processor to perform the method of one or more of Aspects 25-34.

Aspect 59: A non-transitory computer-readable medium storing a set of instructions for wireless communication, the set of instructions comprising one or more instructions that, when executed by one or more processors of a device, cause the device to perform the method of one or more of Aspects 25-34.

Aspect 60: An apparatus for wireless communication at a device, comprising a processor; memory coupled with the processor; and instructions stored in the memory and executable by the processor to cause the apparatus to perform the method of one or more of Aspects 35-44.

Aspect 61: A device for wireless communication, comprising a memory and one or more processors coupled to the memory, the one or more processors configured to perform the method of one or more of Aspects 35-44.

Aspect 62: An apparatus for wireless communication, comprising at least one means for performing the method of one or more of Aspects 35-44.

Aspect 63: A non-transitory computer-readable medium storing code for wireless communication, the code comprising instructions executable by a processor to perform the method of one or more of Aspects 35-44.

Aspect 64: A non-transitory computer-readable medium storing a set of instructions for wireless communication, the set of instructions comprising one or more instructions that, when executed by one or more processors of a device, cause the device to perform the method of one or more of Aspects 35-44.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
transmit, to a network, a session establishment request that includes at least one indication associated with a multicast broadcast service (MBS) session; and
receive, from the network, a response to the session establishment request.

2. The apparatus of claim 1, wherein the session establishment request comprises a protocol data unit (PDU) session establishment request.

3. The apparatus of claim 1, wherein the at least one indication includes a request to join the MBS session.

4. The apparatus of claim 1, wherein the at least one indication comprises an identity associated with the MBS session.

5. The apparatus of claim 4, wherein the identity associated with the MBS session includes a temporary mobile group identity (TMGI) associated with the MBS session, an Internet protocol (IP) address associated with a source of the MBS session, or a combination thereof.

6. The apparatus of claim 1, wherein the response comprises a protocol data unit (PDU) session establishment reject.

7. The apparatus of claim 1, wherein the response comprises a protocol data unit (PDU) session establishment accept.

8. The apparatus of claim 7, wherein the response indicates acceptance of a request to establish a PDU session and includes a cause value associated with rejection of a request to join the MBS session.

9. The apparatus of claim 7, wherein the response indicates acceptance of a request for establishment of a PDU session and acceptance of a request to join the MBS session.

10. The apparatus of claim 1, wherein the network comprises a session management function (SMF), the request is transmitted to the SMF, and the response is received from the SMF.

11. The apparatus of claim 1, wherein the session establishment request includes an indication whether a protocol data unit (PDU) session is only intended for multicast sessions.

12. The apparatus of claim 11, wherein the one or more processors are further configured to:
determine whether the PDU session is only intended for multicast sessions,
wherein the indication included in the session establishment request is based on the determination.

13. An apparatus for wireless communication at a network node, comprising:
a memory; and
one or more processors, coupled to the memory, configured to:
receive, from a user equipment (UE), a session establishment request that includes at least one indication associated with a multicast broadcast service (MBS) session; and
transmit, to the UE, a response to the session establishment request.

14. The apparatus of claim 13, wherein the session establishment request comprises a protocol data unit (PDU) session establishment request.

15. The apparatus of claim 13, wherein the at least one indication includes a request to join the MBS session.

16. The apparatus of claim 13, wherein the at least one indication comprises an identity associated with the MBS session.

17. The apparatus of claim 16, wherein the identity associated with the MBS session includes a temporary mobile group identity (TMGI) associated with the MBS session, an Internet protocol (IP) address associated with a source of the MBS session, or a combination thereof.

18. The apparatus of claim 13, wherein the response comprises a protocol data unit (PDU) session establishment reject.

19. The apparatus of claim 13, wherein the response comprises a protocol data unit (PDU) session establishment accept.

20. The apparatus of claim 19, wherein the response indicates acceptance of a request to establish a PDU session and includes a cause value associated with rejection of a request to join the MBS session.

21. The apparatus of claim 20, wherein the one or more processors are further configured to:
determine to provide establishment of the PDU session with rejection of the request to join the MBS session.

22. The apparatus of claim 21, wherein the session establishment request includes an indication whether the PDU session is only intended for multicast sessions, wherein the determination is based on the indication.

23. The apparatus of claim 19, wherein the response indicates acceptance of a request for establishment of a PDU session and acceptance of a request to join the MBS session.

24. The apparatus of claim 13, wherein the network node is included in a session management function (SMF), the request is received at the SMF, and the response is generated by the SMF.

25. A method of wireless communication performed by a user equipment (UE), comprising:
transmitting, to a network, a session establishment request that includes at least one indication associated with a multicast broadcast service (MBS) session; and
receiving, from the network, a response to the session establishment request.

26. The method of claim 25, wherein the response comprises a protocol data unit (PDU) session establishment reject.

27. The method of claim 25, wherein the response comprises a protocol data unit (PDU) session establishment accept.

28. The method of claim 27, wherein the response indicates acceptance of a request to establish a PDU session and includes a cause value associated with rejection of a request to join the MBS session.

29. The method of claim 27, wherein the response indicates acceptance of a request for establishment of a PDU session and acceptance of a request to join the MBS session.

30. A method of wireless communication performed by a network node, comprising:
receiving, from a user equipment (UE), a session establishment request that includes at least one indication associated with a multicast broadcast service (MBS) session; and
transmitting, to the UE, a response to the session establishment request.
